(19) United States
(12) Patent Application Publication
(10) Pub. No.: US 2009/0307050 A1
(43) Pub. Date: Dec. 10, 2009

(54) Method for Identifying, Rating, and Promoting Desirable Real Estate Listings

(76) Inventor: Michael C. Fournier, Worcester, MA (US)

Correspondence Address: Russ Weinzimmer, 614 Nashua Street, Suite 53, Milford, NH, 03055, US

(21) Appl. No.: 12/135,905

(22) Filed: Jun. 9, 2008

(51) Int. Cl. G06Q 10/00

(52) U.S. Cl. 705/10

(57) ABSTRACT

A method is disclosed for identifying and rating desirable real estate listings and posting them on the internet with other highly desirable listings. An agent may post only one listing at a time, either his/her own listing or, with permission, a listing of another agent. A submitted comparative market analysis (CMA) is validated, or “swept,” after which a “scrubbing” formula is applied to determine “threshold” prices. The listing is only posted if its listing price is below a threshold price. Embodiments include ratings of postings and of posting agents. Additional categories can be included for postings that are not below a threshold price. Listing agent commissions can be higher than posting agent commissions. Referral fees can be paid to listing or posting agents who do not participate in sales that result from postings. In embodiments, an agent cannot post a listing belonging to another agent in the same office.

### FIELD OF THE INVENTION

The invention generally relates to real estate sales, and more specifically to evaluation of real estate properties available for sale.

### BACKGROUND OF THE INVENTION

Real estate sales are usually carried out with the help of licensed real estate professionals, herein referred to as “reps” or “agents,” who are supported by information obtained from at least one multiple listing service, or “MLS.” A real estate professional can also be a realtor, i.e. a member of the Realtors Association.

Typically, a seller interested in selling a real estate property engages the services of a rep who represents the seller as a “sellers agent. The seller's agent generally begins by using an MLS to obtain information regarding comparable properties for sale or recently sold in the same area or in a comparable area, and then uses this information to carry out a “comparative market analysis” or CMA. Based on the CMA, the seller's agent suggests a listing price to the seller, and upon approval by the seller, the selling agent lists the property together with the listing price and other descriptive information on an MLS. Herein, the rep who lists the property on an MLS is referred to as the “listing rep” or “listing agent.”

Similarly, a “Buyer” who wishes to locate and purchase a real estate property will typically, but not always, engage the services of a real estate agent to be his or her “buyer's agent.” The buyer's agent will obtain listings from the MLS of properties for sale that appear to meet the buyer's requirements, and show the most promising ones to the buyer. After the buyer has seen the properties, the buyer will often select one of them and make an offer on it. Possibly after some negotiation, the buyer will then agree to purchase the selected property.

When a real estate transaction is completed, usually a commission is payable to the seller's agent and to the buyer's agent, often in the amount of 6% of the sale price of the property, divided equally between the two agents, and usually paid entirely out of the seller's proceeds from selling the property.

This arrangement has the disadvantage that even though an agent's commission is slightly affected by the final sales price, the primary financial motivation for both the seller's agent and the buyer's agent is to complete transactions as quickly and easily as possible. Hence, a seller's agent has an almost overwhelming incentive to try to convince a seller to agree to a very low listing price, and a buyer's agent has a strong incentive to convince a buyer to make an offer at or near the listing price.

Also, especially in a declining market, other sellers in the market who are faced with an impending foreclosure may choose to offer their property for sale as a “short sale” in which the listing price is set artificially low so as to attempt to sell the property before foreclosure occurs. With approval of the bank or other lending institution (a “third party” to the transaction) the listing price may even be lower than the seller's mortgage, since a sale will allow the bank or other lending institution to avoid the high costs of foreclosure proceedings. If included in a CMA, such short sales will tend to artificially depress the listing price, and will eventually serve as an artificial, downward force on the market.

Many buyers and sellers are aware of these agent motivations and other issues, and so they find themselves in a situation where they are unsure whether or not to trust the information and advice given them by their agent. A seller may receive from his or her agent a list of comparable properties (“comps”), but may suspect that some properties have been omitted from the list so as to artificially make the market appear to be lower than it is. Similarly, a buyer may suspect that any advice received from the buyer's agent is slanted toward encouraging a quick and easy transaction. While a seller and a buyer can try to verify on their own the information received from their agents, the resources available to the average buyer and seller are limited, since they normally to not have access to an MLS, nor do they have the experience to carry out an accurate CMA.

The situation is made even worse by the reporting of national and local real estate trends by the news media. News media often find it desirable to highlight bad news much more than good news, or at least to highlight extreme and unusual news as compared to average and unexciting news. The media may therefore choose to report anecdotal information or information that is specific to certain regions, so as to cause a real estate trend to appear more severe than it actually is. In a market where prices are dropping and real estate is not selling quickly, news media reports can skew the perceptions of sellers and buyers, and thereby make matters even worse. Desperate for more sales in a slow market, agents sometimes try harder than ever to convince sellers to offer low prices. And due to pessimistic reports from the news media, sellers may be even more receptive to such advice. Then, as transactions are completed based on needlessly low listing prices, the real estate market can be made to fall further and more quickly than it otherwise would have fallen if real economic conditions had been the only factor.

Another significant challenge in the current real estate buying and selling system is the sheer quantity of information that is available from MLS services, newspapers, the internet, and other sources. Even if a seller or buyer attempts to do his or her own market analysis, he or she will often be overwhelmed by the large quantity of information available, and may not be able to easily or accurately pick out the most relevant items and make an accurate evaluation. Even reputable and experienced agents who sincerely wish to provide an accurate assessment of a market may find it difficult to make such an analysis due to the sheer quantity of information that must be reviewed. In addition, due to the very large volume of information on MLS services and such like, a seller's agent may find it very difficult to publicize a highly desirable property, and a buyer's agent may find it equally difficult to locate such a property among all of the other available listings. Advertisements, open houses, and such like can be used by a seller's agent to promote a property of high desirability, but these approaches are costly and are often limited both geographically and otherwise in their ability to reach the largest possible range of buyers and buyer's agents.

### SUMMARY OF THE INVENTION

A method is claimed for identifying, rating, and promoting desirable real estate listings. The method provides unbiased, verified, and independent evidence as to the desirability of a listed property, especially with regard to its listing price. The method then promotes listings that qualify as highly desirable listings by providing access to the listings over the internet (“posting” them) in a manner that allows them to be easily identified as highly desirable listings, since they are grouped only with other highly desirable listings.

A real estate agent may post only one listing at a time, which can be either a property that the agent has already listed on an MLS, or, with approval of the listing agent, a property that another agent has already listed on an MLS. Submission of a candidate listing must be accompanied by a comparative market analysis (CMA) and a list of the comparative properties that were used to determine the CMA. The CMA and candidate list are then validated, or “swept,” after which a “scrubbing” formula based on the CMA, assessed value, market trends, real estate absorption rate, and other factors is applied so as to determine applicable “threshold” prices. A candidate listing is only posted if its listing price is below one of the determined threshold prices, and if it also meets certain other posting requirements.

One general aspect of the invention is a method for identifying and promoting desirable real estate listings. The method includes maintaining a server that provides internet access to posted real estate listings of properties for sale, each listing including a listing price. The method further includes accepting from a real estate professional (“posting agent”) a candidate real estate listing that includes a listing price for a candidate property, where the term “candidate real estate listing” refers herein to a listing that has been previously submitted to a real estate listing (MLS) service by a listing real estate representative (“listing agent”) who is not necessarily the posting agent. The method then includes determining at least one threshold price for the candidate real estate listing, where the term “threshold price” refers herein to a price determined according to threshold determining factors that include the assessed value of the property, a comparative market analysis value (CMA value) provided by the posting agent, and the local real estate absorption rate. Finally, the method includes posting the candidate real estate listing on the server if all applicable posting conditions are met, where the applicable posting conditions include that the listing price is below at least one determined threshold price, no other listings of comparable properties are already posted on the server that were accepted from the same posting agent, and, if the listing agent is not the posting agent, that the listing agent has agreed to the posting.

In preferred embodiments, the threshold determining factors further include a market trend factor determined from historical real estate market data and/or an overall real estate market volume.

In certain preferred embodiments, threshold prices are determined according to the formula TP(n)=A*M+n*0.01*[(C/A)̂2]*X*C, in which:

TP(n) is a threshold price;

n is an integer, such that n=1 for a first threshold price, n=2 for a second threshold price, and so forth;

C is the CMA value provided by the posting agent;

M is a market correction factor;

A is the assessed value;

̂2 indicates that (C/A) is squared; and

X is an absorption rate scale factor.

In some of these embodiments M takes on a maximum value at the lowest point of a real estate valuation cycle, and M takes on a minimum value at the highest point of a real estate valuation cycle, and in other of these embodiments M is constrained to be within the range of 0.775 to 0.825. In still other of these embodiments X is constrained to be within the range of 0.5 to 2.0, and in still further of these embodiments X is determined according to the real estate absorption rate and an overall real estate market volume, X being greater for larger absorption rates and for larger overall real estate market volumes.

In certain preferred embodiments, each real estate listing posted on the server is categorized according to how many threshold prices are lower than the listing price for the real estate listing. And in some of these embodiments a category indicating icon is presented together with each real estate listing, the category indicating icon being an indication of how many threshold prices are lower than the listing price for the real estate listing. And in some of these embodiments the category indicating icons for the three lowest categories are red stars for a listing price with no lower threshold prices, white stars for a listing price with one lower threshold price, and blue stars for a listing price with two lower threshold prices.

In various preferred embodiments the method includes validating the CMA by comparing it with comparable listings that are similar to the candidate listing. The comparable listings are found on at least one real estate listing service and are either currently for sale or were sold within the past six months. If the comparison indicates that the CMA is in error, any inconsistent comparable listings are referred (“kicked back”) to the posting agent and the posting agent is required either to revise the CMA, explain why the inconsistent comparable listings should not be considered in determining the CMA, or withdraw the candidate listing.

In some of these preferred embodiments the posting agent provides a list of CMA properties he or she used to determine the provided CMA, and the comparable listings used to validate the CMA are selected from within a radius of the candidate property equal to the distance between the candidate property and the CMA property located furthest from the candidate property.

In other of these preferred embodiments, determination of whether to include a listing found on at least one real estate listing service as part of the validation of the CMA is based on a comparison of criteria with the candidate listing, including at least one of the following: the amount of land included with the property; the living area included with the property; the number of rooms included with the property; the number of bedrooms included with the property; the year the property was built; the number of garage ports included with the property; the number of bathrooms included with the property; the condition of repair of the property; and the comparability of the style of the property with the style of the candidate property.

In certain preferred embodiments, listings posted on the server are made accessible to the general public over the internet without charge, and real estate professionals pay fees so as to post and maintain listings on the server. In other preferred embodiments if a sale of the candidate property results from posting the candidate real estate listing on the server, and if the posting agent is not the listing agent, then after payment of any applicable referral fees the resulting real estate commission is divided into two unequal portions, such that the listing agent receives the larger portion and the posting agent receives the smaller portion. And in some of these embodiments, the difference between the ratio between the portion received by the listing agent and the portion received by the posting agent is 1.67:1 for commissions between 5% and 6% of the sales price of the candidate property, 1.5:1 for commissions between 4% and 5% of the sales price of the candidate property, and 1.29:1 for commissions between 3% and 4% of the sales price of the candidate property.

In preferred embodiments, if the posting agent is not the listing agent, if a buyer purchases a property due to a real estate listing posted on the server, and if the buyer is represented by a buyer's agent who is not the posting agent, then a referral fee is paid to the posting agent, the referral fee being provided equally by the listing agent and the seller's agent. In some of these embodiments the referral fee is equal to the lesser of 0.5% of the sales price of the property and the total of all fees required for a real estate professional to post and maintain listings on the server for a period of one year.

In some preferred embodiments, if the posting agent is not the listing agent, and if a buyer engages services of the posting agent initially due to posting of the candidate real estate listing, but the buyer subsequently purchases a different property with help from the posting agent, then a referral fee is paid to the listing agent by the posting agent. And in some of these embodiments the referral fee is equal to the lesser of 0.5% of the sales price of the property purchased by the buyer and the total of all fees required for a real estate professional to post and maintain listings on the server for a period of one year.

In various preferred embodiments the applicable posting conditions include that if the posting agent is not the listing agent, the posting agent and the listing agent are not associated with the same real estate business entity, and that that posting agent does not already have a property posted on the server.

In certain preferred embodiments, if the posting agent is also the listing agent, any buyer considering purchasing the candidate property and not represented by a real estate professional is informed that the posting agent is also the listing agent, and is also informed of any potential resultant effects on a purchase of the candidate property by the buyer.

In preferred embodiments, if a posting agent is not able to submit a candidate real estate listing that is able to meet all applicable posting conditions, the posting agent can submit a plurality of secondary candidate real estate listings that are comparable to each other and meet all applicable posting conditions, except that the listing price is not below at least one threshold price. The method can then take one of the following actions. First, if the plurality of secondary candidate real estate listings includes at least 20 listings, posting in a “Top Five Percent” category the secondary candidate real estate listing that is closest to a corresponding threshold price. Second, if the plurality of secondary candidate real estate listings includes at least 10 listings, posting in a “Top Ten Percent” category the secondary candidate real estate listing that is closest to a corresponding threshold price. And third, if the plurality of secondary candidate real estate listings includes at least 10 listings and the posting agent is the listing agent for all of the secondary candidate real estate listings, posting in an “Agent's Best” category the secondary candidate real estate listing that is closest to a corresponding threshold price.

In some preferred embodiments the method also includes maintaining ratings of all posting agents who have successfully posted candidate listings on the server and making the ratings available for access over the internet, the ratings being determined according to certain rating factors. And in some of these embodiments the rating factors include the following: the degree to which the posting agent is up to date with applicable continuing education requirements; if and for how long the posting agent has been a member of a board of realtors; a history of transactions in which the posting agent was a buyer's agent; a history of transactions in which the posting agent was a seller's agent; a history of transactions in which the posting agent was a buyer's agent and the transaction involved a candidate listing posted on the server; and a history of transactions in which the posting agent was a seller's agent and the transaction involved a candidate listing posted on the server.

Another general aspect of the invention is a method for independently rating the value of a real estate listing. The method includes accepting the real estate listing from a real estate professional, the listing including a listing price for a listed property and a Comparative Market Analysis (CMA) provided by the real estate professional. The CMA is then validated by comparing it with similar listings found on at least one real estate listing service (MLS) and either currently for sale or sold within the past six months. If the comparison indicates that the CMA is too low, inconsistent listings are referred (“kicked back”) to the real estate professional and the real estate professional is required either to revise the CMA, explain why the inconsistent listings should not be considered in determining the CMA, or withdraw the listing. At least one threshold price for the candidate listing is then determined according to factors that include an assessed value of the property, the CMA value, and a real estate absorption rate. Finally, the listing is rated according to a comparison of the listing price and the at least one threshold price.

Yet another general aspect of the invention is a method for identifying and promoting desirable real estate listings that includes the following steps: maintaining a server that provides internet access to real estate listings of properties for sale that are posted on the server; accepting from a real estate professional (“posting agent”) a candidate real estate listing that includes a listing price; objectively verifying that the listing price of the candidate listing is sufficiently low to allow posting of the candidate listing on the server; and posting the candidate listing on the server if none of the listings already posted on the server were accepted from the same posting agent.

### BRIEF DESCRIPTION OF THE DRAWINGS

FIG. 1A presents a functional diagram of the invention in an embodiment where the posting agent is also the listing agent;

FIG. 1B presents a functional diagram of the invention in an embodiment where the posting agent is not the listing agent;

FIG. 2 presents in “scorecard” format a method used in a preferred embodiment to determine if a real estate listing should be considered “comparable” to a candidate real estate listing for purposes of validating (“sweeping”) a CMA;

FIG. 3 presents a graph illustrating the behavior in a preferred embodiment of the correction factor M in response to a hypothetical six-year market cycle, where M is one of the factors used to calculate pricing thresholds for candidate real estate listings;

FIG. 4 presents a functional diagram indicating circumstances under which a posting agent receives a referral fee from a listing agent and a buying agent when a sale results from a listing posted by the posting agent but the posting agent does not receive a commission;

FIG. 5A presents a functional diagram indicating circumstances under which a listing agent receives a referral fee from a posting agent when a sale results from a listing of the listing agent posted by the posting agent but the sale is of another property, such that the listing agent does not receive a commission;

FIG. 5B presents a functional diagram indicating circumstances under which a potential buyer is informed of possible effects on the sale due to the listing agent being the posting agent and/or the listing agent representing both the seller and the buyer;

FIG. 6A presents a functional diagram illustrating the steps required for a posting agent to post a candidate listing as a “Top Five Percent” listing, when the listing price of the candidate listing is not lower than any of the applicable threshold prices;

FIG. 6B presents a functional diagram of the steps required for a posting agent to post a candidate listing as a “Top Ten Percent” listing, when the listing price of the candidate listing is not lower than any of the applicable threshold prices;

FIG. 6C presents a functional diagram of the steps required for a posting agent to post a candidate listing that was also listed by the posting agent as a “Best of Agent” listing, when the listing price of the candidate listing is not lower than any of the applicable threshold prices;

FIG. 7 presents an illustration of a rating system used in a preferred embodiment to rate real estate professionals who post listings on the server; and

FIG. 8 presents a functional diagram of another general aspect of the present invention that provides verified, unbiased ratings of submitted real estate listings.

### DETAILED DESCRIPTION OF PREFERRED EMBODIMENTS

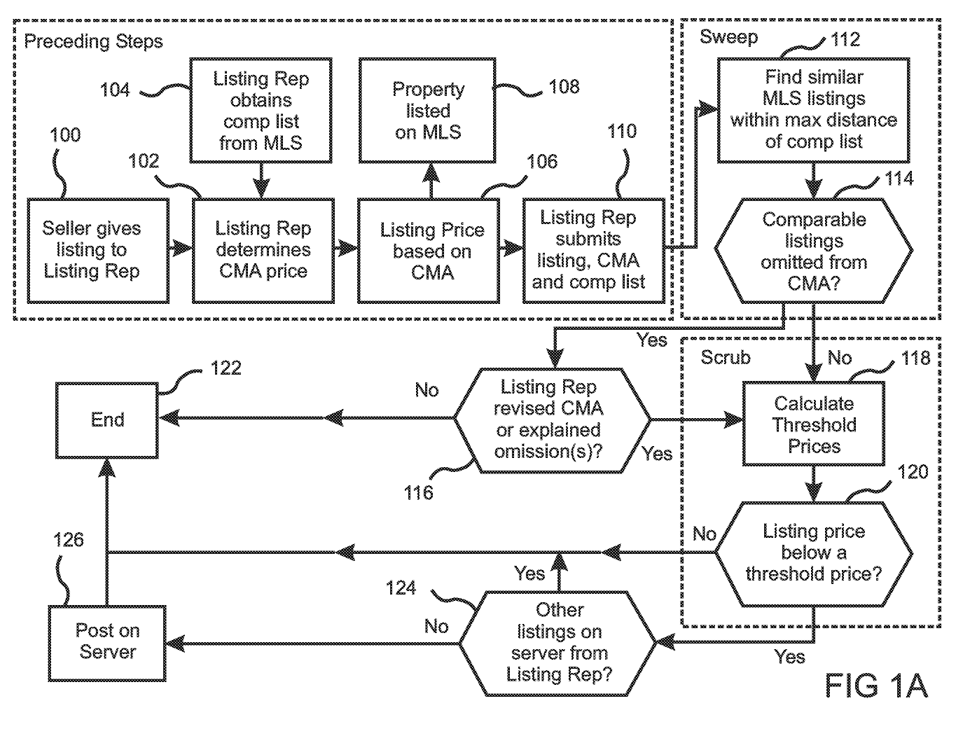

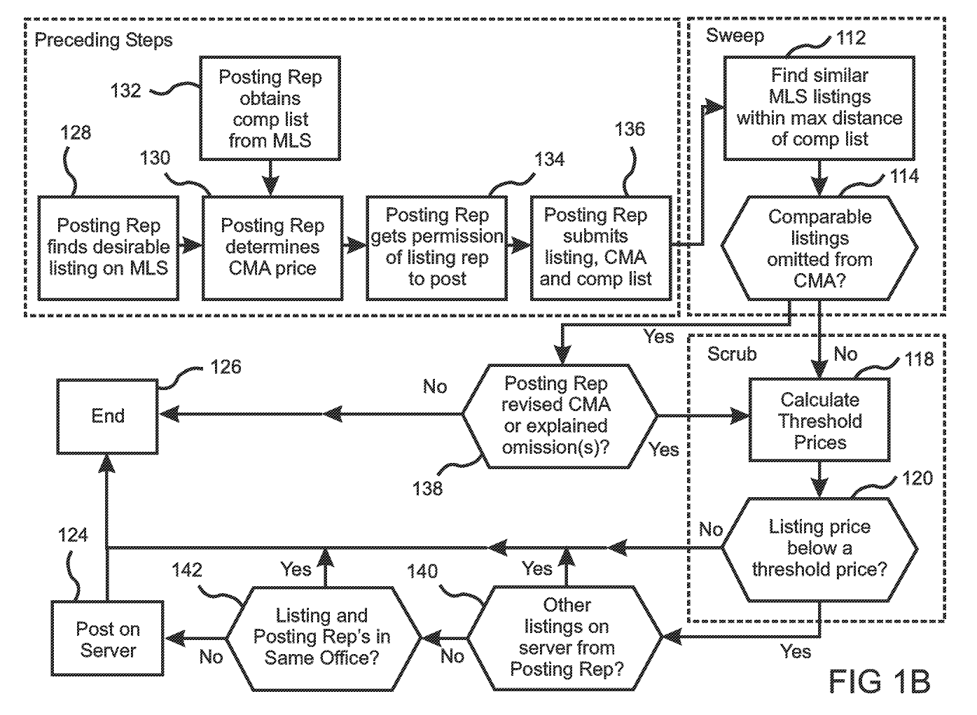

FIG. 1A is a functional diagram that illustrates the method of the present invention in an example where the listing agent is also the posting agent. As illustrated in the figure, several steps precede application of the method. Typically, a seller who wishes to sell a certain real estate property contacts a real estate professional (“agent,” or “rep”) and agrees to allow the agent to represent him or her as the seller's agent or listing agent 100. The listing agent then performs a comparative market analysis (CMA) 102 by making a list of comparable properties (a “comp” list) obtained from a multiple listing service (MLS) 104 and comparing the comp list to the seller's property. Based on the CMA, the listing agent then determines an appropriate listing price 106 and proposes it to the seller. Upon the seller's agreement to the listing price, the listing agent lists the property on the MLS 108.

According to the method of the present invention, the listing agent then presents the listing as a “candidate” listing to be posted on the server. The listing is submitted together with the CMA and the comp list used to determine the CMA 110. According to the present method, the submitted CMA is verified, or “swept,” by obtaining an independent list of comparable properties and comparing them to the CMA 112. In preferred embodiments, the comparable properties are properties that are either currently for sale or sold within the past six months, and that are within a radius of the candidate property that is equal to the distance between the candidate property and the furthest comparable property on the comp list submitted by the listing agent. In some embodiments, if all properties in the comp list submitted by the listing agent are within the same town, only properties from that town are considered in the sweeping process. In further preferred embodiments, “short sale” listings that are artificially reduced in listing price so as to attempt to avoid foreclosure are excluded from the list of comparable properties.

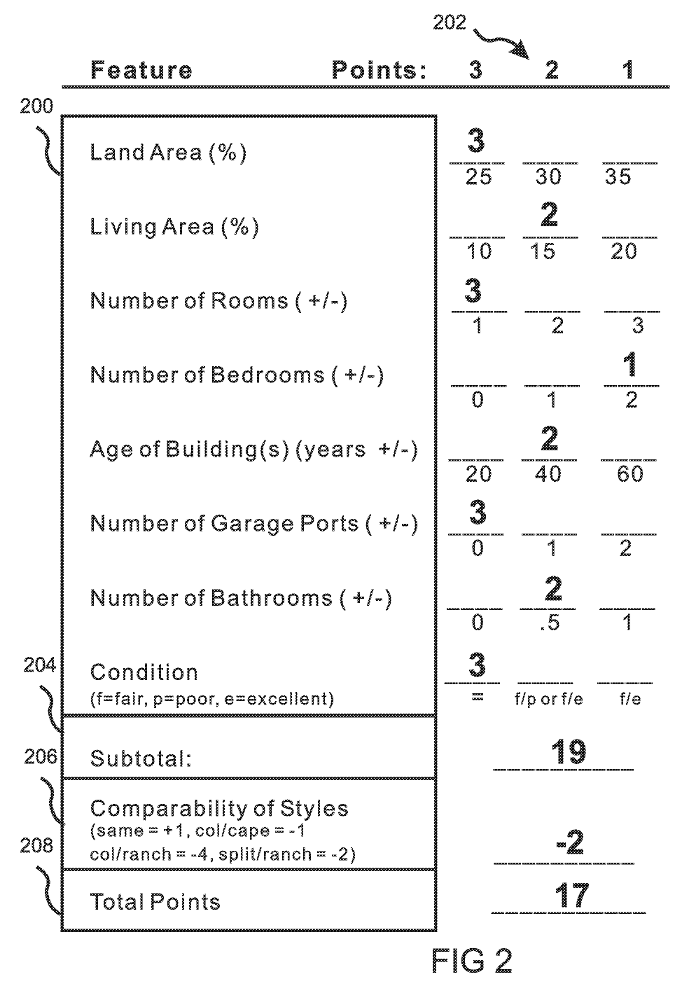

If comparable listings are found during the sweeping process that were not included in the submitted comp list, or that otherwise contradict the CMA as submitted 114, then the omitted and/or contradictory listings are “kicked back” to the listing agent 116 and the listing agent is required either to include them in a revised CMA, explain why they should not be included, or withdraw the candidate listing from consideration. Further details regarding the selection of comparable listings for the sweeping process are presented in reference to FIG. 2 below.

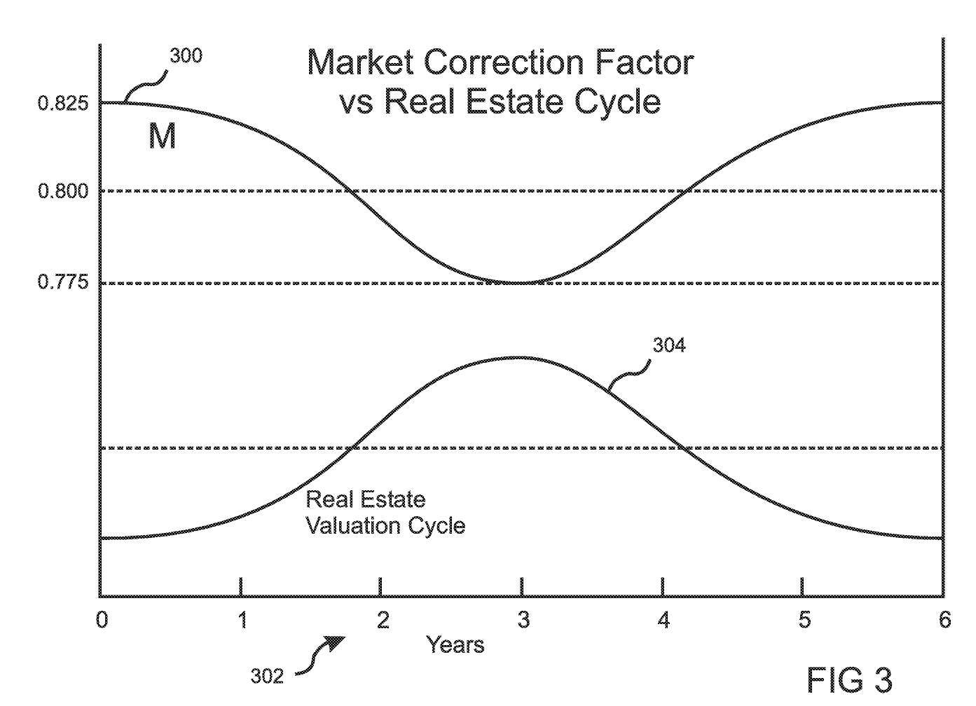

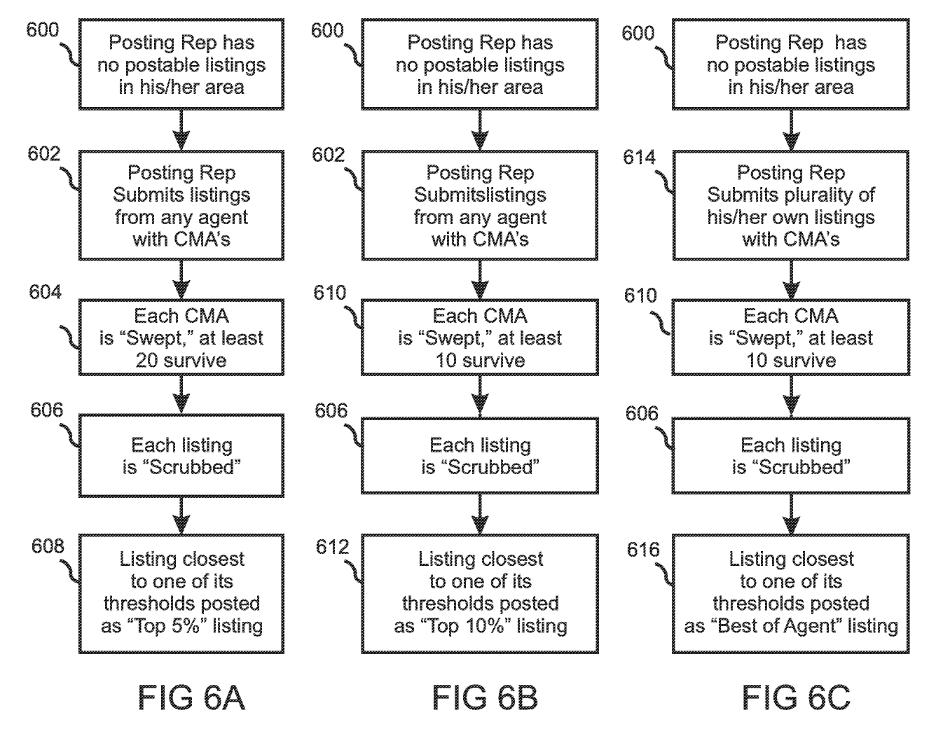

Once the sweeping process has been completed, a “scrubbing” process begins. In the scrubbing process, a set of one or more threshold prices is calculated 118 according to the CMA, the assessed value of the property, current market trends, the local real estate absorption rate, and possibly other factors. Further details regarding the scrubbing process are presented in reference to FIG. 3 below. If the listing price is above all of the threshold prices 120, then in the basic method of FIG. 1A the candidate listing is rejected 122, and is not posted on the server. In some embodiments, described in more detail with reference to FIG. 6A, FIG. 6B, and FIG. 6C below, if an agent is not able to submit a candidate listing with a listing price below at least one threshold price, the agent can present a plurality of candidate listings and, under certain circumstances described in more detail below in reference to FIG. 6A through 6C, the candidate listing for which the listing price is closest to a threshold price (i.e. the “best” of the submitted candidate listings) can be posted under a special category even though the listing price is not below any of the threshold prices.

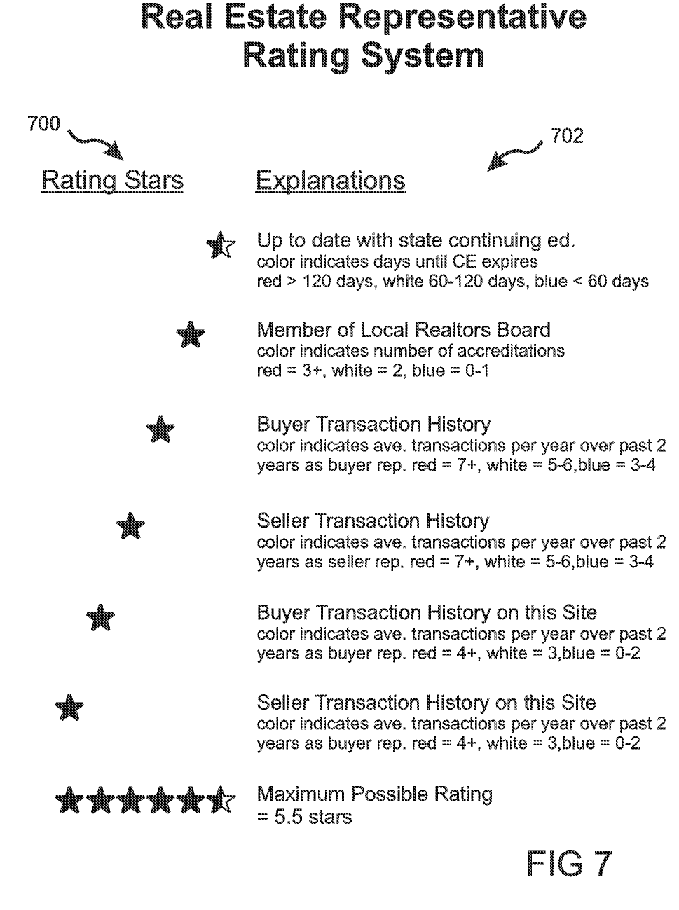

If the candidate listing price is below at least one threshold price 120, and if none of the other listings currently posted on the server were submitted by the same agent 124, then the candidate listing is posted on the server 126 and made available for access over the internet. In various embodiments, additional information is provided together with the listing, such as an indication of how many thresholds are below the listing price, and/or a rating of the posting agent (where in this example the listing agent is the posting agent). An example of an agent rating system is discussed in more detail with reference to FIG. 7 below.

With reference to FIG. 1B, the method operates in a similar manner if the posting agent is not the listing agent. Often, a real estate professional (in this example referred to as the “posting agent”) may notice a listing, for example on an MLS, listed by another agent (the “listing agent”) that seems to be highly desirable 128. The posting agent may perform his or her own CMA 130 by obtaining similar listings from an MLS 132, and upon confirming that the listing is highly desirable, the posting agent may wish to make strong efforts to find a buyer for the listing so as to receive the buyer's agent share of the resulting commission. The listing agent may have already posted another listing on the server of the present invention, and so the listing agent may be more than happy to give permission 134 the posting agent to post the listing as the posting agent's listing. The method then proceeds in a manner very similar to FIG. 1A, with the posting agent submitting the listing 136 as a candidate listing for posting on the server and responding if necessary 138 after the CMA has been “swept,” If the listing survives the sweeping and scrubbing processes, if there are no other postings on the server from the same posting agent 140, and after verifying that the listing agent and the posting agent are not part of the same real estate business entity 142, the candidate listing is posted on the server 126. When a sale due to a posted listing takes place for which the listing agent is not the posting agent, and for which the posting agent is the seller's agent, a commission is divided between the listing agent, who is also the seller's agent, and the posting agent, who is also the buyer's agent. In preferred embodiments, the commission is divided unequally between the two agents, with the listing agent receiving the larger portion. In some preferred embodiments, so as to encourage listing agents to allow their listings to be posted by unrelated posting agents, the ratio of the portions of the commission received by the listing agent and the posting agent are 1.67:1 for commissions between 5% and 6% of the purchase price, 1.5:1 for commissions between 4% and 5% of the purchase price, and 1.29:1 for commissions between 3% and 4% of the purchase price, where in all cases the portions are calculated after deducting any referral fees owed to other parties, such as to banks.

FIG. 2 presents a method from a preferred embodiment used to select comparable properties as part of the sweeping process of verifying a CMA. In this embodiment, a property is compared with the candidate property in terms of several features 200, including the land area, the living area, total number of rooms, the number of bedrooms, the age of the building, the number of garage ports, the number of bathrooms, and the overall conditions of the properties. A score 202 from 1 to 3 is assigned to each of these categories, and a subtotal is made. A correction is then applied according to the comparability of the styles of the two properties. In the embodiment of FIG. 2, a point is added if the two styles are the same, a point is subtracted if a colonial is compared to a cape, four points are subtracted if a colonial is compared to a ranch, and two points are subtracted if a split-level is compared to a ranch. If the final total, after applying the correction factor, is greater than 16, the property is considered to be comparable to the candidate property and is included in the sweep.

The “scrubbing” process of the present invention includes applying a formula to derive one or more “threshold” prices for a candidate listing. In various embodiments, factors included in the formula include the CMA, the assessed value, the local real estate absorption rate, and the current market trend, i.e. where the market is currently located in terms of an expected real estate market cycle. In one embodiment, the formula used to determine threshold prices is:

TP(n)=A*M+n*0.01*[(C/A)̂2]*X*C

in which TP is a threshold price and n is an integer, such that the first threshold price is denoted as TP(1), the second threshold price as TP(2), and so forth. In this formula, C is the CMA value, M is a market correction factor, A is the assessed value of the property, “̂2” indicates that (C/A) is to be squared, and X is a factor that depends on the market absorption rate.

FIG. 3 graphically presents the behavior in preferred embodiments of M 300 during a hypothetical six-year period 302 during which the market 304 undergoes a typical cycle. In this embodiment, the correction factor M 300 is constrained to range between the values of 0.775 and 0.825, and behaves such that it is greatest when the market 304 is at the bottom of a cycle, and least when the market 304 is at the top of a cycle. This is because a property can be expected to rise rapidly when purchased at the bottom of a market cycle, and so deserves a higher sales price compared to a property purchased at the top of a market cycle and therefore expected to drop in value over the near term, or at least not to rise very quickly.

In a preferred embodiment, for a property listed at the mid-point of a declining market, M behaves according to the following, with variations within the stated ranges dependant on the absorption rate and the ratio of the CMA to the assessed value:

M ranges from 0.80 to 0.82 during the first 6 to 12 months after listing;

M ranges from 0.81 to 0.83 between 12 and 18 months after listing;

M ranges from 0.82 to 0.84 between 18 and 24 months after listing;

M ranges from 0.85 to 0.88 between 24 and 30 months after listing;

M ranges from 0.86 to 0.89 between 30 and 36 months after listing;

M ranges from 0.88 to 0.90 between 36 and 42 months after listing; and

M ranges from 0.89 to 0.91 between 42 and 48 months after listing.

In various preferred embodiments, the absorption rate factor X is constrained to be within the range of 0.5 to 2.0, and/or is determined according to the real estate absorption rate and the overall real estate market volume, X being greater for larger absorption rates and for larger overall real estate market volumes.

As an example of an embodiment that uses the formula presented above, if the CMA for a home is $250,000, it is assessed at $200,000, M=0.8 (middle of an upward or downward market cycle), and X=1.5 (absorption rate and market volume are strong), then the calculated thresholds would be:

$$\begin{matrix}TP ( 1 ) = [ 0.8 * \$200 , 000 ] + 1 * [ .01 * ( 250 / 200 ) \hat{} 2 * 1.5 * \$250 , 000 ] \\ = \$160 , 000 + ( 1.25 ) \hat{} 2 * 1.5 * \$2500 \\ = \$160 , 000 + \$5859 \\ \$165 , 859 \\ TP ( 2 ) = \$171719\end{matrix}$$

and in general, TP(n)=$165,000+n*($5859), where the results have been rounded to whole dollars. In this example, if the listing price were at or below $165,859 then it would be posted with the highest rating. If it were between $165,860 and $171,719 it would be posted with the next highest rating, and so forth. In preferred embodiments, the total number of thresholds is three, so that each posted candidate listing falls into one of three threshold categories. In some preferred embodiments the ratings are indicated by graphical icons, such as red, white, and blue stars, presented cooperatively with the posted listings. And in some embodiments a rating remains fixed for a certain period of time, such as 30 days, even if the listing price is changed in the meantime, although in some of these embodiments a notation of a listing price change can be included with the posted listing.

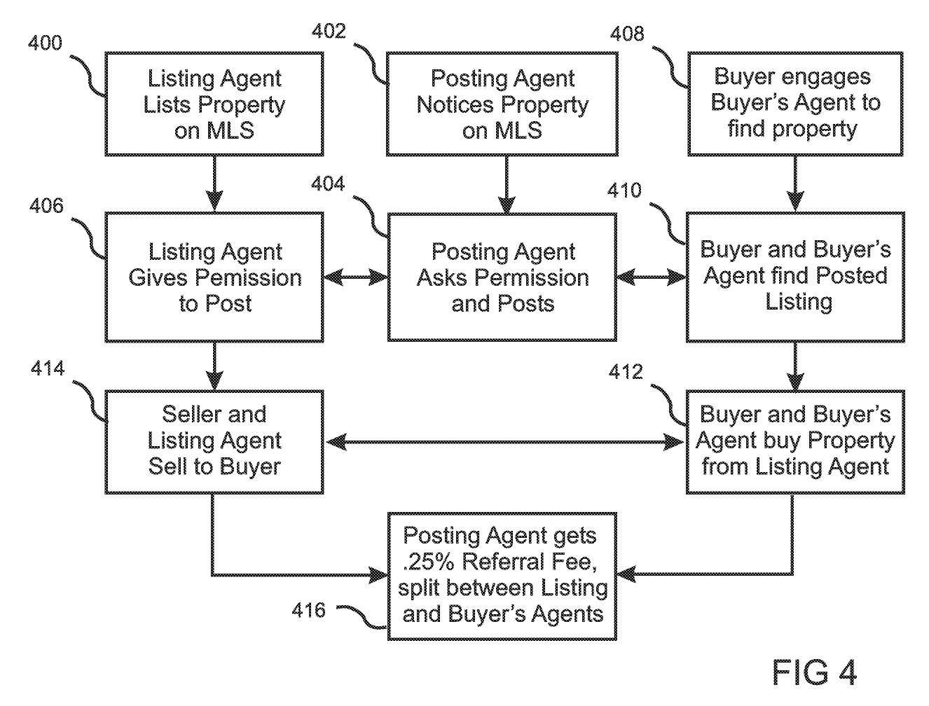

FIG. 4 is a functional diagram that indicates payment, in preferred embodiments, of a referral fee to a posting agent when a posting leads to a sale, but the posting agent is neither the listing agent nor the buyer's agent, and so is not entitled to a commission. In the scenario of FIG. 4, the listing agent lists the property on an MLS 400, and the posting agent notices the property on the MLS 402 and determines that it is a highly desirable property. The posting agent then contacts the listing agent and asks permission to post the property on the server of the present invention 404, and since the listing agent already has a property posted on the server and is therefore not eligible to post a second property, the listing agent gladly gives permission for the posting 406.

Meanwhile, a buyer engages the services of a buyer's agent 408 to help in finding a property for the buyer to purchase. The buyer and/or the buyer's agent find the posting on the server of the present invention 410 and make a purchase offer 412 directly to the listing agent and the seller. The offer is accepted 414, but the posting agent is not due a commission, since the posting agent is neither the seller's (i.e. the listing) agent nor the buyer's agent. However, the posting agent clearly played a positive role in initiating the sale, and for this reason, the posting agent receives a referral fee 416, divided equally between the seller's agent and the buyer's agent, and equal to either 0.25% of the selling price or the total of all fees required for a real estate professional to post and maintain listings on the server for a period of one year, whichever is less.

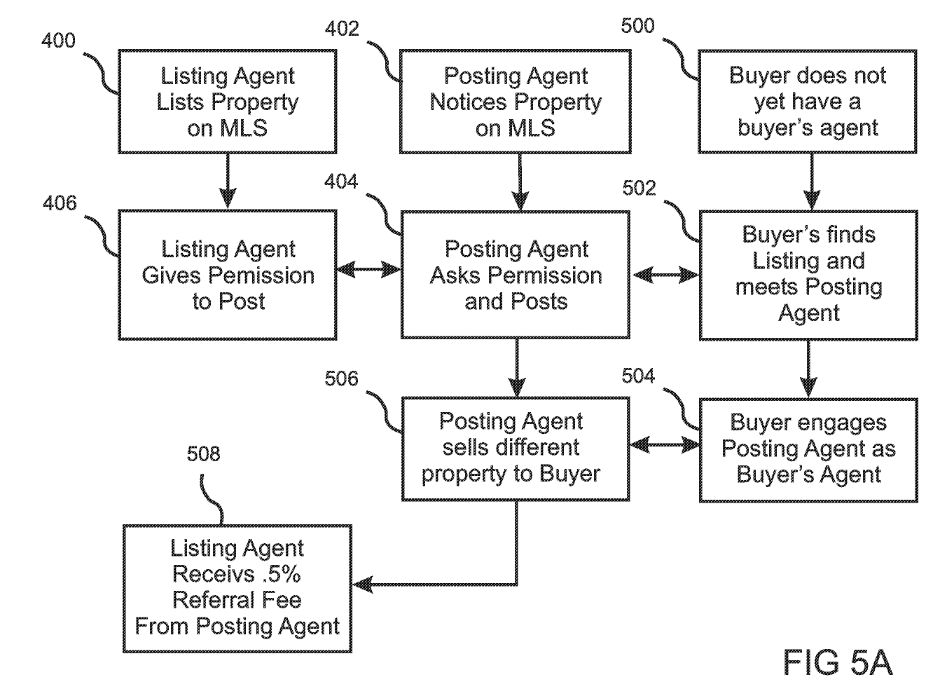

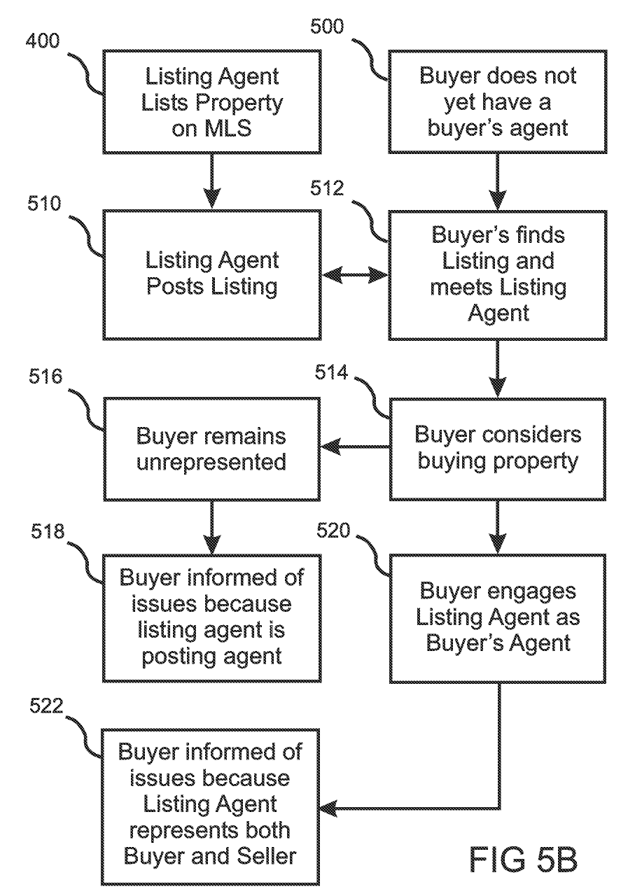

A scenario from a preferred embodiment in which a listing agent receives a referral fee from a posting agent is illustrated by the functional diagram of FIG. 5A. As in the previous example, a listing agent lists a property on an MLS 400, and a posting agent notices the listing and determines that it is highly desirable 402. The posting agent then asks for permission to post the listing 404, and the listing agent gives permission 406. At this point, a buyer who has not yet engaged a buyer's agent 500 locates the posted listing on the internet, and directly contacts the posting agent 502. Note that in this embodiment, postings on the server are freely available over the internet to everyone, while real estate professionals are required to pay a subscription fee so as to be allowed to maintain postings on the server.

After contacting the posting agent and considering the posted property, the buyer decides not to purchase the posted property, but instead engages the posting agent as a buyer's agent 504 and eventually purchases another property 506 with the help of the posting agent. In this case, the listing agent of the first property does not receive a commission, even though he or she has clearly assisted in the transaction by providing a mechanism whereby the posting agent was brought into contact with the buyer. The listing agent therefore receives a referral fee 508 from the posting agent equal to 0.5% of the purchase price of the property purchased by the buyer, or the total of all fees required for a real estate professional to post and maintain listings on the server for a period of one year, whichever is lower.

FIG. 5B illustrates a scenario similar to FIG. 5A in which the buyer does not yet have a buyer's agent 500 and the listing agent is the posting agent 510. In this case the buyer finds the listing and contacts the listing agent 512, and considers buying the property 514. If the buyer remains unrepresented 516, the buyer is automatically informed 518 of issues that may result from purchasing the property due to the fact that the posting agent is also the listing agent. For example, although not officially the buyer's agent, the posting agent may appear to be advising the buyer, while actually representing the seller. If the buyer engages the listing agent as the buyer's agent 520, the buyer is informed of issues that may result due to the fact that the listing agent is representing both the buyer and the seller 522.

FIG. 6A through FIG. 6C are functional diagrams that describe embodiments in which a real estate agent who is not able to post a listing of interest for which the listing price would be lower than a threshold price can nevertheless post a listing on the server under an alternative category. In FIG. 6A, an agent has no listings in his or her area of interest 600 for which the listing price is lower than a threshold price. Instead, the agent submits a plurality of desirable candidate listings, together with corresponding CMA's, as candidates for posting under a special category 602. The CMA for each submitted listing is swept 604, and if at least 20 submitted candidate listings survive the sweeping process they are scrubbed to determine pricing thresholds 606. Finally, the listing for which the listing price is closest to (although higher than) a corresponding threshold price is posted in a “Top 5%” category.

Similarly, as indicated in FIG. 6B, in preferred embodiments if less than 20 but at least 10 submitted candidate listings survive the sweeping process 610, the listing for which the listing price is closest to (although higher than) a threshold price is listed in a “Top 10%” category 612. Finally, as illustrated in FIG. 6C, in preferred embodiments an agent can submit a plurality of his or her own listings, i.e. listings for which the agent is the listing agent 614, and if at least 10 of the submitted listings survive the sweeping process the submitted listing for which the listing price is closest to (although higher than) a threshold price is listed in a “Best of Agent” category.

In preferred embodiments, when a candidate listing is posted on the server, information pertaining to the posting agent is also posted. FIG. 7 presents a rating system from a preferred embodiment in which stars 700 are awarded to each posting agent according to six different categories 702. Each star is colored “red” “white” or “blue” to indicate levels of achievement within each category. In the preferred embodiment of FIG. 7, the agent is awarded 1/2 star if he or she is up to date in meeting applicable state continuing education requirements, and a full star if he or she is a member of the local real estate board. Additional stars are awarded according to overall “real world” degrees of success as a buyer's and a seller's agent, as well as degrees of success as a buyer's or seller's agent in completing transactions involving listings posted on the server of the present invention. The stars are awarded according to rolling two-year averages of completed transactions, the averages being calculated every three months. In the rating system of FIG. 7, the maximum possible rating is 5.5 stars. The colors of some or all of the stars are influenced by whether or not the agent is a member of the local board of realtors, such that real estate board members qualify more easily for a higher color rating. Also, in some preferred embodiments, completion of accreditation courses reduces the number of sales that must be completed so as to earn a higher rating as a “real world” buyer's or seller's agent, thereby providing an educational incentive for agents.

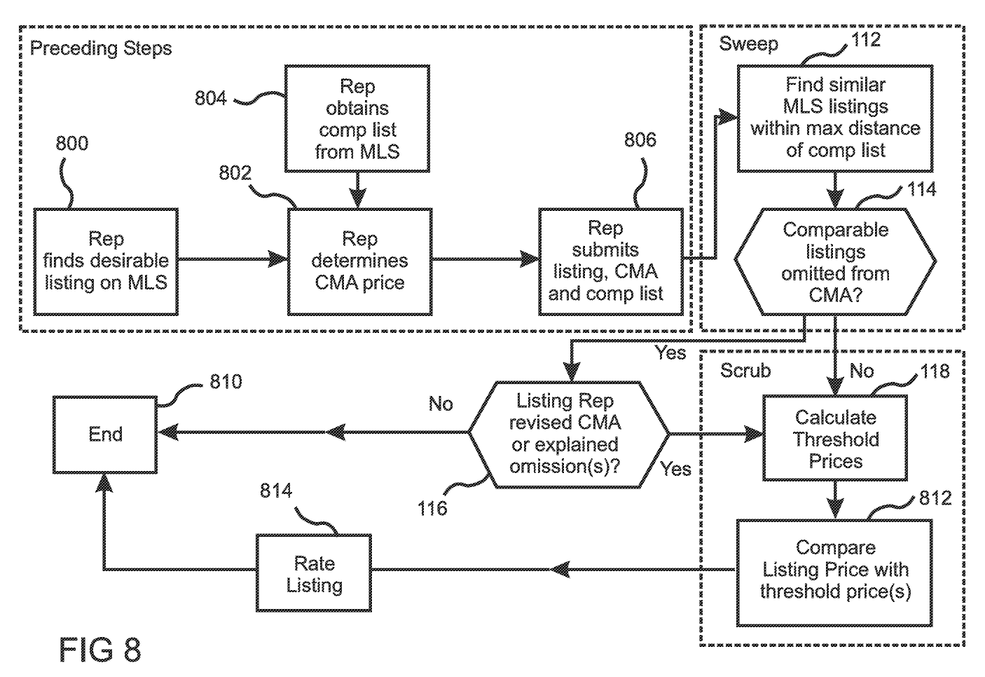

With reference to FIG. 8, another general aspect of the invention is a method for rating the desirability of a real estate listing. In the embodiment of FIG. 8, an agent finds a desirable listing on an MLS 800 and determines a CMA price 802 based on comparable listings also obtained from the MLS 804. The agent then submits the desirable listing, along with the CMA and the comp list 806, at which point the listing is “swept,” as described above with reference to FIG. 1A, so as to verify that no comparable listings were omitted. If the listing does not survive the sweeping process the rating method is aborted 810. If it survives the sweeping process, the listing is then “scrubbed” to determine its threshold prices, the threshold prices are compared with the listing price 812, and a rating is determined from the comparison 814.

Other modifications and implementations will occur to those skilled in the art without departing from the spirit and the scope of the invention as claimed. Accordingly, the above description is not intended to limit the invention except as indicated in the following claims.

1. A method for identifying and promoting desirable real estate listings, the method comprising:
maintaining a server that provides internet access to real estate listings of properties for sale that are posted on the server, each of the posted listings including a listing price;
accepting from a real estate professional (“posting agent”) a candidate real estate listing that includes a listing price for a candidate property, the term “candidate real estate listing” referring herein to a listing that has been previously submitted to a real estate listing service by a listing real estate representative (“listing agent”) who is not necessarily the posting agent;
determining at least one threshold price for the candidate real estate listing, the term “threshold price” referring herein to a price determined according to threshold determining factors that include an assessed value of the candidate property, a comparative market analysis value (CMA value) provided by the posting agent, and a real estate absorption rate; and
posting the candidate real estate listing on the server if all applicable posting conditions are met, the applicable posting conditions including that:
the listing price is below at least one threshold price;
no other listings of comparable properties already posted on the server were accepted from the same posting agent; and
if the listing agent is not the posting agent, the listing agent has agreed to the posting.

2. The method of claim 1, wherein the threshold determining factors further include at least one of:
a market trend factor determined from historical real estate market data; and
an overall real estate market volume.

3. The method of claim 1, wherein threshold prices are determined according to the formula TP(n)=A*M+n*0.01*[(C/A)̂2]*X*C, in which:
TP(n) is a threshold price;
n is an integer, such that n=1 for a first threshold price, n=2 for a second threshold price, and so forth;
C is the CMA value provided by the posting agent;
M is a market correction factor;
A is the assessed value;
̂2 indicates that (C/A) is squared; and
X is an absorption rate scale factor.

4. The method of claim 3, wherein M takes on a maximum value at the lowest point of a real estate valuation cycle, and M takes on a minimum value at the highest point of a real estate valuation cycle.

5. The method of claim 3, wherein M is constrained to be within the range of 0.775 to 0.825.

6. The method of claim 3, wherein X is constrained to be within the range of 0.5 to 2.0.

7. The method of claim 3, wherein X is determined according to the real estate absorption rate and an overall real estate market volume, X being greater for larger absorption rates and for larger overall real estate market volumes.

8. The method of claim 1, wherein each real estate listing posted on the server is categorized according to how many threshold prices are lower than the listing price for the real estate listing.

9. The method of claim 8, wherein a category indicating icon is presented together with a real estate listing, the category indicating icon being an indication of how many threshold prices are lower than the listing price for the real estate listing.

10. The method of claim 9, wherein the category indicating icons for the three lowest categories are red stars for a listing price with no lower threshold prices, white stars for a listing price with one lower threshold price, and blue stars for a listing price with two lower threshold prices.

11. The method of claim 1, further comprising validating the CMA by:
comparing the CMA with comparable listings that are similar to the candidate listing, the comparable listings being found on at least one real estate listing service and referring to properties either currently for sale or sold within the past six months; and
if the comparison indicates that the CMA is in error, referring inconsistent comparable listings to the posting agent and requiring that the posting agent do one of:
revise the CMA;
explain why the inconsistent comparable listings should not be considered in determining the CMA; and
withdraw the candidate listing.

12. The method of claim 11, wherein the posting agent provides a list of CMA properties used by the posting agent to determine the provided CMA, and the comparable listings used to validate the CMA are selected from within a radius of the candidate property equal to the distance between the candidate property and the CMA property located furthest from the candidate property.

13. The method of claim 11, wherein determination of whether to include a listing found on at least one real estate listing service as part of the validation of the CMA is based on a comparison of criteria with the candidate listing, including at least one of:
amount of land included with the property;
living area included with the property;
number of rooms included with the property;
number of bedrooms included with the property;
year the property was built;
number of garage ports included with the property;
number of bathrooms included with the property;
condition of repair of the property; and
comparability of style with the candidate property.

14. The method of claim 1, wherein listings posted on the server are made accessible to the general public over the internet without charge, and real estate professionals pay fees so as to post and maintain listings on the server.

15. The method of claim 1, further comprising, if a sale of the candidate property results from posting the candidate real estate listing on the server, and if the posting agent is not the listing agent, after payment of any applicable referral fees, dividing a resulting real estate commission into two unequal portions such that the listing agent receives the larger portion and the posting agent receives the smaller portion.

16. The method of claim 15, wherein the ratio between the portion received by the listing agent and the portion received by the posting agent is:
1.67:1 for commissions between 5% and 6% of a sales price of the candidate property;
1.5:1 for commissions between 4% and 5% of the sales price of the candidate property; and
1.29:1 for commissions between 3% and 4% of the sales price of the candidate property.

17. The method of claim 1, further comprising, if the posting agent is not the listing agent, if a buyer purchases a property due to a real estate listing posted on the server, and if the buyer is represented by a buyer's agent who is not the posting agent, paying a referral fee to the posting agent provided equally by the listing agent and the seller's agent.

18. The method of claim 17, wherein the referral fee is equal to the lesser of 0.25% of a sales price of the property and a total of all fees required for a real estate professional to post and maintain listings on the server for a period of one year.

19. The method of claim 1, further comprising, if the posting agent is not the listing agent, and if a buyer engages services of the posting agent initially due to posting of the candidate real estate listing but subsequently purchases a different property with help from the posting agent, paying of a referral fee to the listing agent by the posting agent.

20. The method of claim 19, wherein the referral fee is equal to the lesser of 0.5% of a sales price of the property purchased by the buyer and a total of all fees required for a real estate professional to post and maintain listings on the server for a period of one year.

21. The method of claim 1, wherein the applicable posting conditions further include at least one of:
if the posting agent is not the listing agent, the posting agent and the listing agent are not associated with the same real estate business entity; and
no other listings of any properties already posted on the server were accepted from the same posting agent.

22. The method of claim 1, further comprising, if the posting agent is also the listing agent, informing any buyer considering purchasing the candidate property and not represented by a real estate professional other than the listing agent, that the posting agent is also the listing agent, and also informing the buyer of any potential resultant effects on a purchase of the candidate property by the buyer due to at least one of:
the posting agent is the listing agent; and
the listing agent is acting on behalf of both a seller and the buyer.

23. The method of claim 1, further comprising, if a posting agent is not able to submit a candidate real estate listing that is able to meet all applicable posting conditions, accepting instead from the posting agent a plurality of secondary candidate real estate listings that are comparable to each other and meet all applicable posting conditions except that the listing price is not below at least one threshold price, and one of:
if the plurality of secondary candidate real estate listings includes at least 20 listings, posting in a “Top Five Percent” category the secondary candidate real estate listing that is closest to a corresponding threshold price;
if the plurality of secondary candidate real estate listings includes at least 10 listings, posting in a “Top Ten Percent” category the secondary candidate real estate listing that is closest to a corresponding threshold price; and
if the plurality of secondary candidate real estate listings includes at least 10 listings and the posting agent is the listing agent for all of the secondary candidate real estate listings, posting in an “Agent's Best” category the secondary candidate real estate listing that is closest to a corresponding threshold price.

24. The method of claim 1, further comprising maintaining ratings of all posting agents who have successfully posted candidate listings on the server, the ratings being determined according to certain rating factors, and making the ratings available for access over the internet.

25. The method of claim 24, wherein the rating factors include at least one of:
a degree to which the posting agent is up to date with applicable continuing education requirements;
if and for how long the posting agent has been a member of a board of realtors;
a number of accreditation courses completed a history of transactions in which the posting agent was a buyer's agent;
a history of transactions in which the posting agent was a seller's agent;
a history of transactions in which the posting agent was a buyer's agent and the transaction involved a candidate listing posted on the server; and
a history of transactions in which the posting agent was a seller's agent and the transaction involved a candidate listing posted on the server.

26. A method for independently rating the value of a real estate listing, the method comprising:
accepting the real estate listing from a real estate professional, the listing including a listing price for a listed property and a Comparative Market Analysis (CMA) provided by the real estate professional;
validating the CMA by comparing it with similar listings found on at least one real estate listing service for properties either currently for sale or sold within the past six months;
if the comparison indicates that the CMA is too low, referring inconsistent listings to the real estate professional and requiring that the real estate professional do one of revise the CMA, explain why the inconsistent listings should not be considered in determining the CMA, and withdraw the listing;
determining at least one threshold price for the candidate listing according to factors that include an assessed value of the candidate property, the CMA value, and a real estate absorption rate; and
rating the listing according to a comparison of the listing price and the at least one threshold price.

27. A method for identifying and promoting desirable real estate listings, the method comprising:
maintaining a server that provides internet access to real estate listings of properties for sale that are posted on the server;
accepting from a real estate professional (“posting agent”) a candidate real estate listing that includes a listing price;
objectively verifying that the listing price of the candidate listing is sufficiently low to allow posting of the candidate listing on the server; and
posting the candidate listing on the server if none of the listings already posted on the server were accepted from the same posting agent.
